(19) United States
(12) Patent Application Publication
(10) Pub. No.: US 2006/0190922 A1
(43) Pub. Date: Aug. 24, 2006

(54) Method and system for managing and tracking software development lifecycles

(76) Inventor: Franz Chen, San Jose, CA (US)

Correspondence Address: WHITE-WELKER & WELKER, LLC, P.O. BOX 199, CLEAR SPRING, MD, 21722-0199, US

(21) Appl. No.: 11/169,819

(22) Filed: Jun. 29, 2005

Related U.S. Application Data
(60) Provisional application No. 60/655,760, filed on Feb. 24, 2005.

(51) Int. Cl. G06F 9/44

(52) U.S. Cl. 717/100

(57) ABSTRACT

The invention is a system and method for managing and tracking software development lifecycle using a request report that captures the draft of requirements. The four elements are: a requirement management module that processes request reports, a test case management module that processes test case reports, a defect management module that processes defect reports, and project management module that processes task reports. The request report contains a workflow and information organized into folders. The test case report can be created via a request report and contains workflow and information organized into folders. The defect report can be created via the test case report and contains workflow and information organized into folders. The task report may be created via the request report, test case report, or defect report.

### CROSS REFERENCE TO RELATED APPLICATIONS

This application claims priority from U.S. Provisional Patent Application Ser. No. 60/655,760, entitled “Method and System for Managing and Tracking Software Development Lifecycles”, filed on 24 Feb. 2004.

### TECHNICAL FIELD OF THE INVENTION

The present invention relates generally to project management processes. More specifically the present invention relates to a system and method for managing and tracking software development lifecycles.

### BACKGROUND OF THE INVENTION

Many software systems integrate modules to assist user in managing the software development lifecycle. These solutions typically aggregate multiple functionalities. For example, a system may have a requirement management module that allow user to manage requirement, a test management module that allows user to manage tests, a defect management module that allows user to manage defects, and a project management module that allow user to manage assignments.

The integration of a set of functionalities is a common method to facilitate user access with a single sing-in credential. It provides little or no information regarding the rationales of a software development and actions taken in updating and executing requirements. It is desirable to have a system and method that allow user to track the entire development lifecycle using the report that captured the initial requirements.

### SUMMARY OF THE INVENTION

In accordance with the present invention a system and method for managing and tracking software development lifecycle using a request report that captures the draft of requirements that overcomes the aforementioned problems of the prior art. The four elements are: a requirement management module that processes request reports, a test case management module that processes test case reports, a defect management module that processes defect reports, and project management module that processes task reports.

The present invention provides mechanisms to trace the development lifecycle by storing a pair of reciprocated IDs using pointer arrays in data structures of selected reports. The following describes pointer arrays in data structures of request reports, test case reports, defect reports, and task reports.

This invention provides mechanisms to trace rationales of a development with method and data structures for storing information in a systematic and controlled manner. The mechanism consists of three basic data sets in request, test case, and defect reports; a “Details” data set to store updated attributes of the reports, a “History” data set to store information related to changes made to the report, and a “Notes” data set to store written communications among participants. The following described methods are for applying these data sets.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a block diagram illustrating the system;

FIG. 2 is a block diagram illustrating the embodiment of the mechanisms in a request report using arrays of pointers in the data structure;

FIG. 3 is a block diagram illustrating the embodiment of the mechanisms in a test case report using arrays of pointers in the data structure;

FIG. 4 is a block diagram illustrating the embodiment of the mechanisms in a defect report using arrays of pointers in the data structure;

FIG. 5 is a block diagram illustrating the embodiment of the mechanisms in a task report using arrays of pointers in the data structure;

FIG. 6 is a screen capture illustrating an implementation of request reports;

FIG. 7 is a screen capture illustrating an implementation of test case reports;

FIG. 8 is a screen capture illustrating an implementation of defect reports;

FIG. 9 is a screen capture illustrating an implementation of task reports.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The invention is a system 28 and method for managing and tracking software development lifecycle using a request report that captures the draft of requirements. The four elements are: a requirement management module that processes request reports 2, 29, and 35 a test case management module that processes test case reports 1, 27, and 30, a defect management module that processes defect reports 3 and 32, and project management module 33 that processes task reports 34, 28, 36, 37, 38, and 39.

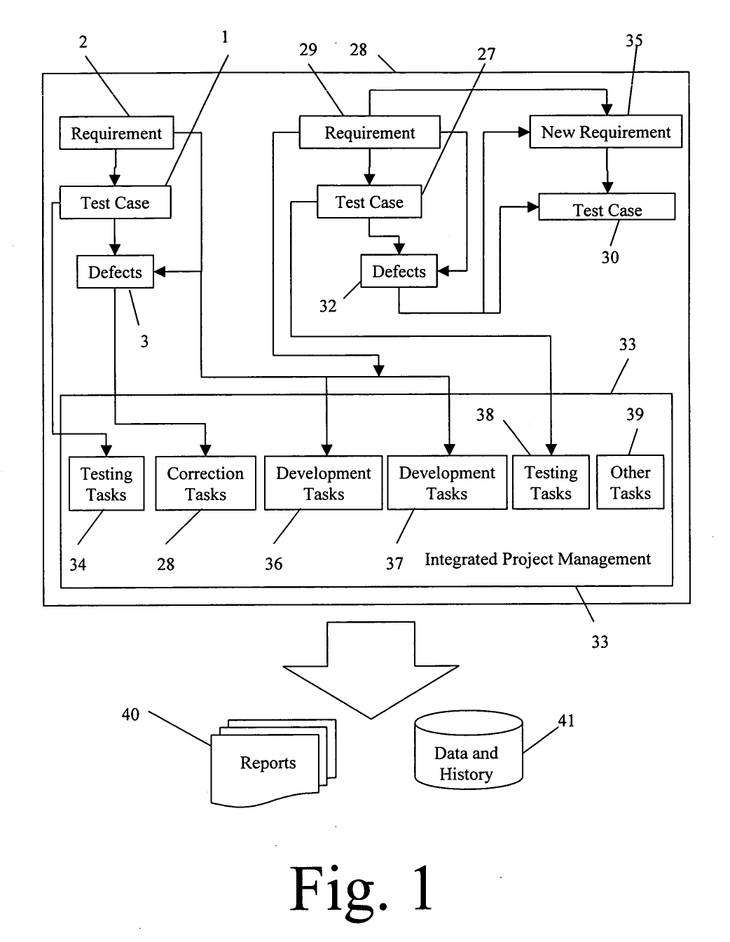

Now referring to FIG. 1, a block diagram illustrating the interaction of modules in the system described below is provided. A test case report 1 can be created via a request report 2. A defect report 3 can be created via a test case report 1. While Test case reports 5 can be created via a defect reports 32. Additionally, Request reports 35 can be created via a defect report 32 or via another request report 29. Attributes of a request report 29 can be copied to a defect report 32. Then, attributes of a defect report 32 can be copied to a request report 35.

Development tasks 36 and 37 can be created via request reports 2 and 29. A development task 36 can be associated to multiple request reports 2 and 29. Testing tasks 34 and 38 can be created via test case reports 1 and 27. A testing task 38 can be associated with multiple test case reports 1 and 27. Also, correction tasks 28 can be created via a defect report 3. The correction task 28 can also be associated with multiple defect reports 3 and 32. Finally, all tasks are managed under the project management module 33.

The present invention provides mechanisms to trace the development lifecycle by automatically pairing and exchanging report IDs and storing them with arrays in data structures provided in the selected reports. The following describes these arrays and mechanisms in request reports, test case reports, defect reports, and task reports.

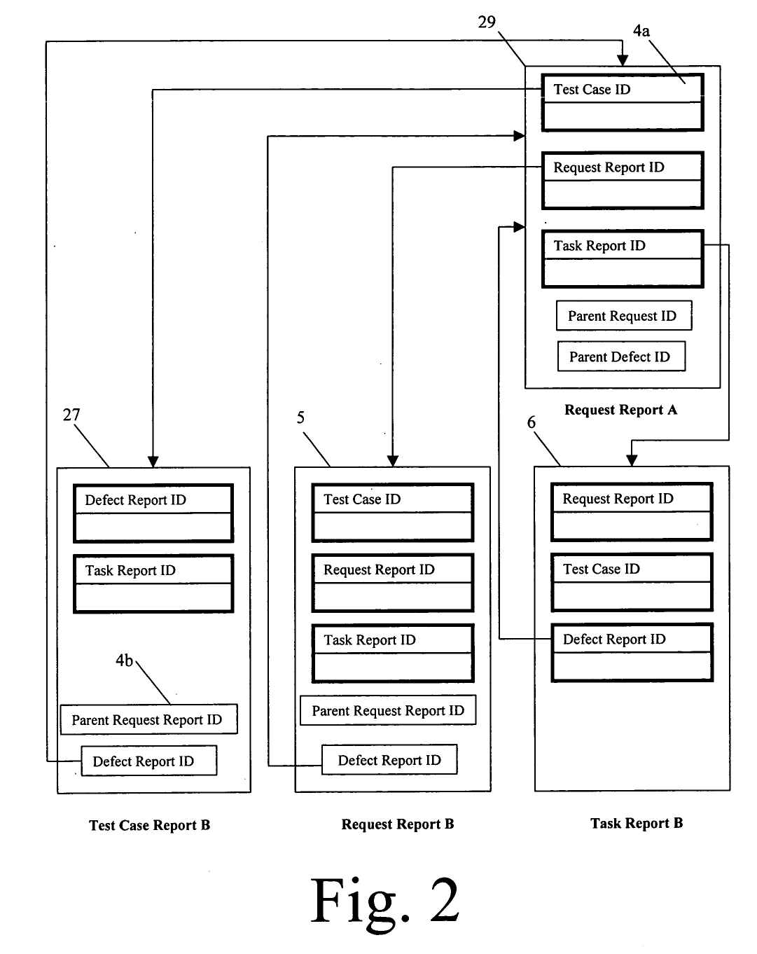

Now referring to FIG. 2, a block diagram with the embodiment of the mechanisms and data structure in a request report is illustrated. The data structure 29 contains a set of data arrays and attributes that identify target reports, an array stores IDs of relevant test case reports 27, an array stores IDs of request reports 5, an array stores IDs of task reports 6, an attribute stores the ID of the parent request report 29 with which the request report 5 is created, and an attribute stores the parent defect report with which the request report is created. An array can be empty or contain multiple IDs. For each ID in the data structure of the request report, there is a corresponding data element in the target that stores the ID of the request report. This pair of IDs ensures the tractability. The IDs are filled automatically by the system when targets are created or associated.

For example, when the user creates a test case report via the request report, the system will insert the ID of the test case report in the array of request report 4a and the ID of the request report in the attribute 4b of test case report. This request report is known as the “Parent Request Report” 4b to the test case report.

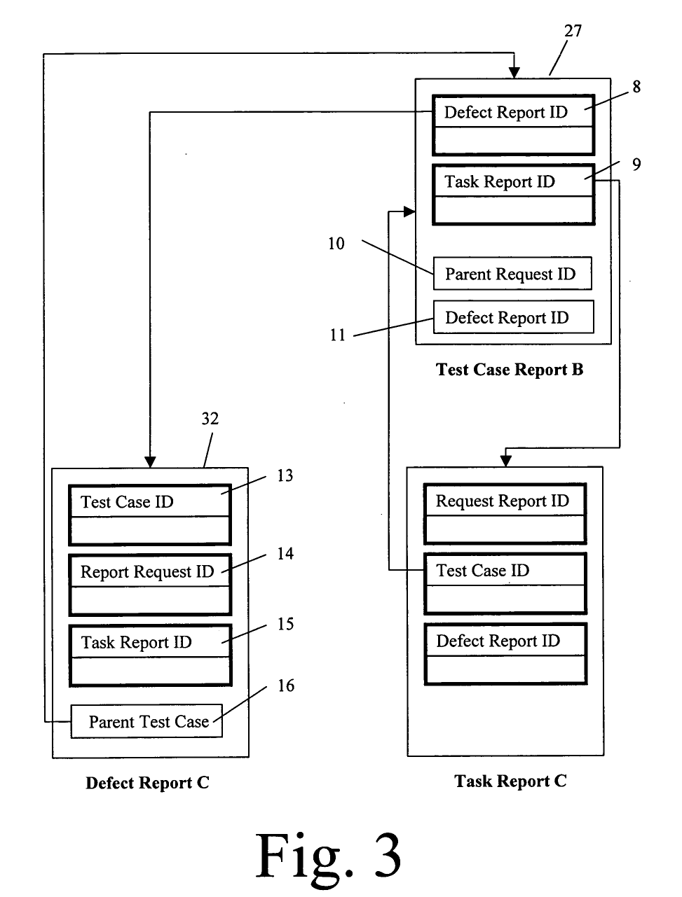

FIG. 3 is a block diagram illustrating the embodiment of the mechanisms and data structure in a test case report B 27. The data structure contains a set of data arrays and attributes that identify target reports, an array stores IDs of defect reports 8, an array stores IDs of task reports 9, an attribute stores the ID of the parent request report 10 with which the test case report is created, and an attribute stores the ID of the parent defect report 11 with which the test case is created. An array can be empty or contain multiple IDs. For each ID in the data structure of the test case report B 27, there is a corresponding data element in the target that stores the ID of the test case. This pair of IDs ensures the desired tractability. The IDs are filled automatically by the system when targets are created or associated.

For example, when the user creates a defect report via a test case report, the system will insert the ID of defect report in the array 8 of test case report and ID of the test case report in the attribute 16 of defect report. This test case report is known as the “Parent Test Case” 16 to the defect report

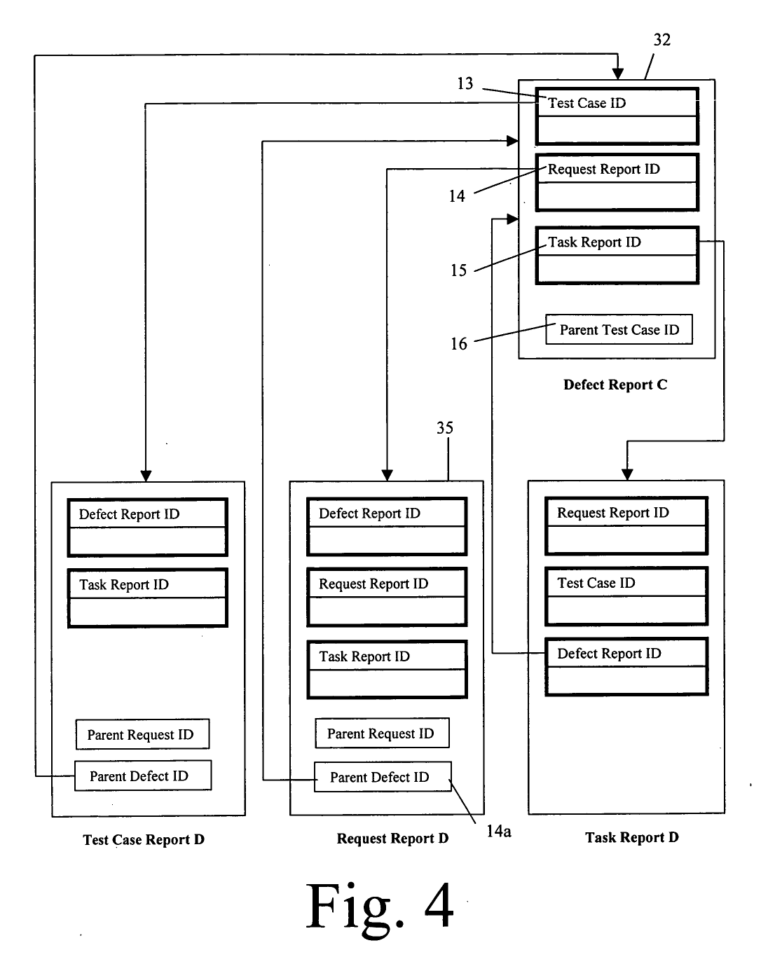

Now referring to FIG. 4, a block diagram illustrating the embodiment of the mechanisms and data structure in a defect report C 32. The data structure contains a set of data arrays and an attribute that identify target reports, an array 13 stores IDs of test cases, an array 14 stores IDs of request reports, an array 15 stores IDs of task reports, and an attribute stores the ID 16 of the parent test case report with which the defect report is created. An array can be empty or contain multiple IDs. For each ID in the data structure of the defect report 32, there is a corresponding data element in the target that stores the ID of the defect report. This pair of IDs ensures the desired tractability. The IDs are filled automatically by the system when targets are created or associated.

For example, when the user creates a request report via a defect report, the system will insert the ID of the request report in the array 14 of defect report and ID of the defect report in the attribute 14a of request report. This defect report is known as the “Parent Defect” to the request report.

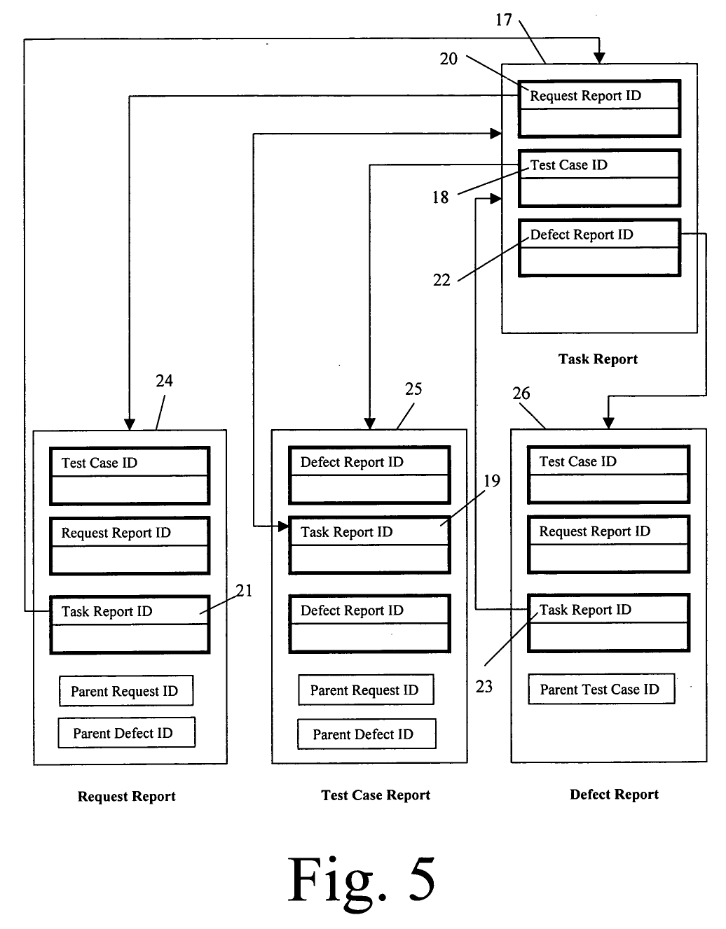

FIG. 5 is a block diagram illustrating the embodiment of the mechanisms and data structure in a task report 17. The data structure contains a set of data arrays with report IDs 20,18,22 that identify its association with request reports 24, test case reports 25, and defect reports 26 in the system. Each array may store none or numerous IDs. For each ID in the data structure of task report 17 there is a corresponding data element in the targets 19, 21, and 23 that stores the ID of the task report. This pair of IDs ensures the desired tractability. The IDs are filled automatically by the system when a task is created or referenced in request reports, test case reports, and defect reports.

This invention provides mechanisms and methods to progressively collect information that allow users to trace rationales of a development. The mechanism consists of three basic data sets organized into folders for request reports, test case reports, and defect reports; a “Details” folder has the data set to store attributes of the report 41, a “Relevant Test Cases” folder 43 contains test cases that describes scenarios and the use of the development result(s) a “History” folder has the data set 46 to store information related to changes made to the report, and a “Notes” folder has the data set to store written communications among participants 44. The following described methods are for applying these data sets.

FIG. 6 is a screen capture illustrating an implementation with a workflow and above-mentioned folders in a request report. A “Details” folder 41 contains attributes of requirements, a “Relevant Test Cases” folder 43 contains test cases that describes scenarios and the use of the development result(s), a “Notes” folder 44 contains written discussions, and a “History” folder 46 contains changes made to the description of the requirements and the request report. When a request report is created, attributes of requirements are captured and stored under the “Details” folder 41. These attributes may not provide sufficient information in specifying a development.

There are two sets of mechanisms to assist user in clarifying the requirements. First, users can add test cases reports under the “Relevant Test Cases” folder 43 to describe the scenarios and the use of the result(s). These descriptions clarify the expectations of the development. Second, users can use messaging mechanism under the “Notes” folder 44 to ask and answer questions regarding the attributes in the “Details” folder and test case reports under the “Relevant Test Cases”. The trail of the communication under the “Notes” folder 44 are time stamped and can be used to correlate with the changes that are logged under the “History” folder 46 to infer the rationales of the change.

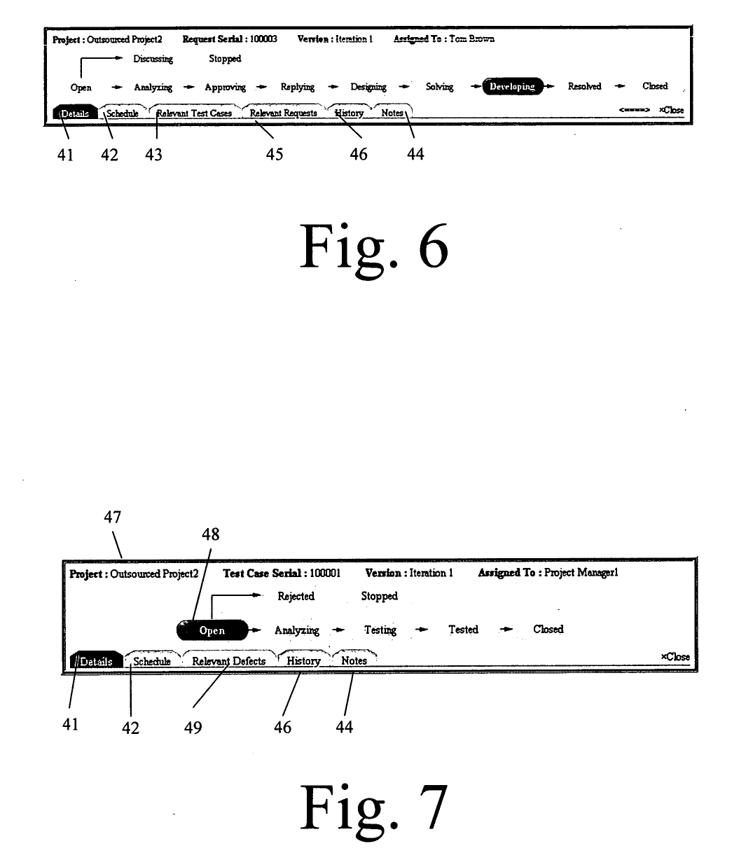

FIG. 7 is a screen capture illustrating an implementation of the test case report 47 with a workflow 48 and folders. Similar to FIG. 6, there is a “Details” folder, a “History” folder, and “Notes” folder.

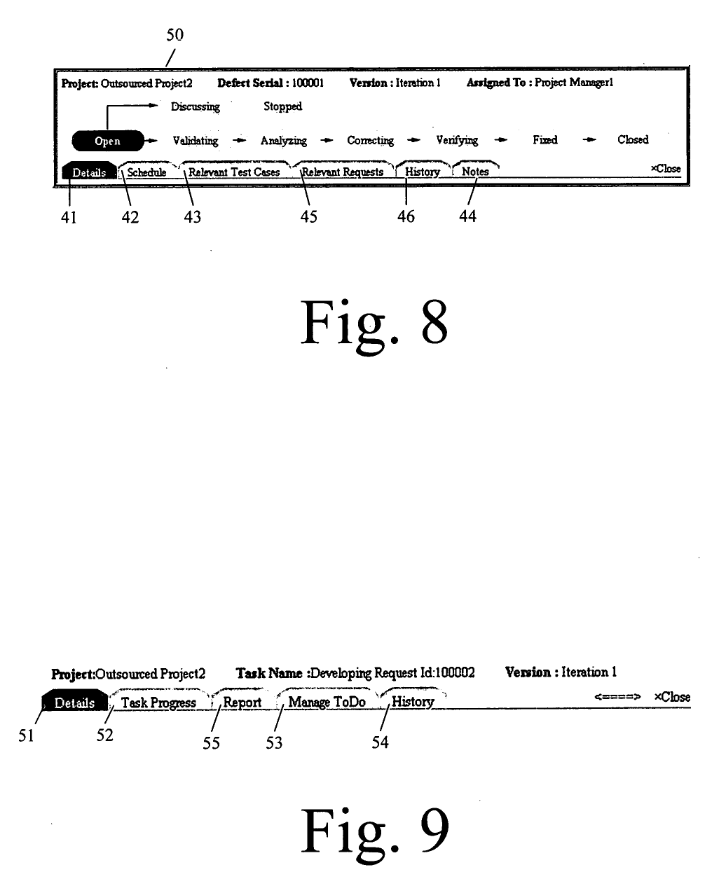

Now referring to FIG. 8, a screen capture of an implementation of a workflow and folders in a defect report 50 is illustrated. Similar to FIG. 6, the report contains a “Details” folder, a “History” folder, and “Notes” folder.

FIG. 9 is a screen capture illustrating an implementation of the task report with the folders. The “Details” folder 41 captures the attributes of a task, a “Task Progress” folder 52 contains metrics of reported and calculated efforts, a “Manage ToDo” folder 53 contains a list of request, test case, and defect reports that are associated with the task, and a “History” folder 54 contains changes made to the report and progress updates of the task.

While the invention has been described in terms of several embodiments and illustrative figures, those skilled in the art will recognize that the invention is not limited to the embodiments or figures described. In particular, the invention can be practiced in several alternative embodiments that provides a mechanisms and/or process for building software applications.

Therefore, it should be understood that the method and apparatus of the invention can be practiced with modification and alteration within the spirit and scope of the appended claims. The description is thus to be regarded as illustrative instead of limiting on the invention.

1. A method for managing and tracking a software development lifecycle using a request report that captures the draft of requirements comprising:
a requirement management module that processes request reports;
a test case management module that processes test case reports;
a defect management module that processes defect reports; and
a project management module that processes task reports.

2. The method for managing and tracking a software development lifecycle of claim 1 further comprising a mechanism to trace rationales of a development with method and data structures for storing information in a systematic and controlled manner.

3. The method for managing and tracking a software development lifecycle of claim 2 wherein the mechanism consists of three basic data sets in said request reports, test case reports, and defect reports;
a Details data set to store updated attributes of the reports;
a History data set to store information related to changes made to the report; and
a Notes data set to store written communications among participants.

4. The method for managing and tracking a software development lifecycle of claim 3 wherein
test case reports can be created via a request report;
defect reports can be created via a test case report;
test case reports can be created via a defect reports;
request reports can be created via a defect report or any other request report;
attributes of a request report can be copied to a defect report; and
attributes of a defect report can be copied to a request report.

5. The method for managing and tracking a software development lifecycle of claim 4 wherein
development tasks can be created via request reports;
said development tasks can be associated with multiple request reports;
testing tasks can be created via test case reports;
said testing tasks can be associated with multiple test case reports;
correction tasks can be created via a defect report;
said correction task can also be associated with multiple defect reports; and
all tasks are managed under a project management module.

6. The method for managing and tracking a software development lifecycle of claim 5 further comprising mechanisms to trace the development lifecycle by automatically pairing and exchanging report IDs and storing them with arrays in data structures provided in the selected reports.

7. The method for managing and tracking a software development lifecycle of claim 6 wherein said data structures contains a set of data arrays and attributes are used in request reports.

8. The method for managing and tracking a software development lifecycle of claim 7 wherein an array can be empty or contain multiple IDs.

9. The method for managing and tracking a software development lifecycle of claim 7 wherein
said data structure contains a set of data arrays and attributes that identify target reports;
a data array stores IDs that uniquely identify related test case reports,
a data array stores IDs that uniquely identify related request reports; and
a data array stores IDs that uniquely identify related task reports.

10. The method for managing and tracking a software development lifecycle of claim 7 wherein
an attribute stores the ID of the parent request report with which the request report is created and
an attribute stores the ID of parent defect report with which the request report is created.

11. The method for managing and tracking a software development lifecycle of claim 7 wherein for each ID in the data structure of a request report, there is a corresponding data element in the target that stores the ID of the request report.

12. The method for managing and tracking a software development lifecycle of claim 11, 15, 18, or 21 wherein the IDs are filled automatically by the system when targets are created or associated.

13. The method for managing and tracking a software development lifecycle of claim 6 wherein said data structures contains a set of data arrays and attributes are used in test case reports.

14. The method for managing and tracking a software development lifecycle of claim 13 wherein
said data structure contains a set of data arrays and attributes that identify target reports;
a data array stores IDs that uniquely identify related defect reports,
a data array stores IDs that uniquely identify related task reports,
an attribute stores the ID of the parent request report, and
an attribute stores the ID of the parent defect report.

15. The method for managing and tracking a software development lifecycle of claim 13 wherein for each ID in the data structure of the test case report, there is a corresponding data element in the target that stores the ID of the test case report.

16. The method for managing and tracking a software development lifecycle of claim 6 wherein said data structures contains a set of data arrays and attributes are used in defect reports.

17. The method for managing and tracking a software development lifecycle of claim 16 wherein
the data structure contains a set of data arrays and an attribute that identify target reports;
a data array stores IDs that uniquely identify related test cases;
a data array stores IDs that uniquely identify related request reports;
a data array stores IDs that uniquely identify related task reports; and
an attribute stores the ID of the parent test case report with which the defect report is created.

18. The method for managing and tracking a software development lifecycle of claim 17 wherein for each ID in the data structure of the defect report, there is a corresponding data element in the target that stores the ID of the defect report.

19. The method for managing and tracking a software development lifecycle of claim 6 wherein said data structures contains a set of data arrays and attributes are used in task reports.

20. The method for managing and tracking a software development lifecycle of claim 19 wherein the data structure contains:
a set of data arrays with report IDs that identify its association with request reports;
test case reports, and
defect reports in the system.

21. The method for managing and tracking a software development lifecycle of claim 20 wherein for each ID in the data structure of task report there is a corresponding data element in the targets that stores the ID of the task report.

22. A mechanism for progressively collecting information that allow a user to trace rationales of a development cycle wherein the mechanism consists of a plurality of data sets organized into folders for request reports, test case reports, and defect reports.

23. The mechanism for progressively collecting information that allow a user to trace rationales of a development cycle of claim 22 further comprising:
a Details folder that has the data set to store attributes of the report,
a Relevant Test Cases folder that contains test case reports that describes scenarios and the use of the development results,
a History folder which has the data set to store information related to changes made to a report, and
a Notes folder that has the data set to store written communications among participants.

24. The mechanism for progressively collecting information that allow a user to trace rationales of a development cycle of claim 23 further comprising two s mechanisms to assist a user in clarifying the requirements:
users can add test cases reports under the Relevant Test Cases folder to add test case reports that describe the scenarios and the use of the results; and
users can use an online messaging mechanism under the Notes folder, to ask and answer questions regarding the attributes in the Details folder and test case reports under the Relevant Test Cases, which are time stamped and can be used to correlate with the changes that are logged under the History folder to infer the rationales of the change.
